(19) United States
(12) Patent Application Publication
(10) Pub. No.: US 2022/0395432 A1
(43) Pub. Date: Dec. 15, 2022

(54) SYSTEMS, METHODS, AND APPARATUSES FOR AN ANTI-COLIC AIRPATH FOR A BOTTLE

(71) Applicant: MAPA GmbH, Zeven (DE)

(72) Inventors: Kevin Thomas BAYONNET, Uniontown, OH (US); Reiner PILS, Kalbe (DE); Uwe WAGENKNECHT, Tostedt (DE); Torsten HASTEDT, Heeslingen (DE)

(73) Assignee: MAPA GmbH, Zeven (DE)

(21) Appl. No.: 17/806,463

(22) Filed: Jun. 10, 2022

Related U.S. Application Data
(60) Provisional application No. 63/210,114, filed on Jun. 14, 2021.

(51) Int. Cl. A61J 9/00

(52) U.S. Cl. CPC A61J 9/006

(57) ABSTRACT

An apparatus may include an insert configured to be positioned between a nipple and an opening of a bottle when the nipple is mounted to the bottle. The insert is configured to facilitate airflow out of the bottle and through an interface between the nipple and the bottle when the nipple is dispensing fluid from within the bottle. A system may include a nipple, the insert, and a bottle with an opening. A method may include providing the insert, and positioning the insert between a nipple and an opening of a bottle when the nipple is mounted to the bottle.

### CROSS-REFERENCE TO RELATED APPLICATIONS

The present applications claims the benefit of U.S. Provisional No. 63/210,114, filed on Jun. 14, 2021, which is incorporated by reference in its entirety.

### TECHNICAL FIELD

The present disclosure is generally directed to bottles, and more particularly to systems, methods, and apparatuses for an anti-colic airpath for a bottle.

### BACKGROUND

Certain infant bottles are well-known in the art. Infant bottles include nipples that mimic the look and feel of a human nipple so that infants latch to the infant bottle nipple naturally. Nipples that are difficult to use by infants can cause frustration when fluid is discharged slowly or with irregularity. In some instances, air in the bottle can be introduced into the fluid causing air bubbles in the fluid when the fluid is consumed by the infant from the bottle. In other instances, as the fluid is consumed by the infant from the bottle, a vacuum can build up within the bottle, inhibiting or sometimes preventing fluid flow from the nipple. In any instance, such occurrences can lead to colic or related symptoms in the infant feeding from the bottle.

### SUMMARY

The present disclosure describes systems, methods, and apparatuses for an anti-colic airpath for a bottle. In embodiments, an apparatus includes an insert configured to be positioned between a nipple and an opening of a bottle when the nipple is mounted to the bottle. The insert is configured to facilitate airflow out of the bottle and through an interface between the nipple and the bottle when the nipple is dispensing fluid from within the bottle.

In embodiments, a system includes a nipple, an insert, and a bottle with an opening. The insert is positioned between the nipple and the opening of the bottle when the nipple is mounted to the bottle. The insert is configured to facilitate airflow out of the bottle and through an interface between the nipple and the bottle when the nipple is dispensing fluid from within the bottle.

In embodiments, a method includes providing an insert, and positioning the insert between a nipple and an opening of a bottle when the nipple is mounted to the bottle. The insert facilitates airflow out of the bottle and through an interface between the nipple and the bottle when the nipple is dispensing fluid from within the bottle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is an illustrative perspective view of a system and apparatus in accordance with one example embodiment of the disclosure.

FIG. 1B is an illustrative cross-sectional view of the system and apparatus of FIG. 1A.

FIG. 2 is an illustrative perspective view of an apparatus for an anti-colic airpath for a bottle in accordance with one example embodiment of the disclosure.

FIG. 3 is an illustrative side view of the apparatus shown in FIG. 2 in accordance with one example embodiment of the disclosure.

FIG. 4 is an illustrative overhead view of the apparatus shown in FIGS. 2 and 3 in accordance with one example embodiment of the disclosure.

FIG. 5 is an illustrative underside view of the apparatus shown in FIGS. 2-4 in accordance with one example embodiment of the disclosure.

FIG. 6 is an illustrative side view of the apparatus shown in FIGS. 2-5 in accordance with one example embodiment of the disclosure.

FIG. 7 is an illustrative sectional view of the apparatus shown in FIGS. 2-6 in accordance with one example embodiment of the disclosure.

FIG. 8 is an illustrative cross-sectional view of a system and apparatus for an anti-colic airpath for a bottle in accordance with one example embodiment of the disclosure.

FIG. 9 is an illustrative perspective view of an apparatus for an anti-colic airpath for a bottle in accordance with one example embodiment of the disclosure.

FIG. 10 is an illustrative perspective view of the apparatus shown in FIG. 9 in accordance with one example embodiment of the disclosure.

FIG. 11 is an illustrative overhead view of the apparatus shown in FIGS. 9 and 10 in accordance with one example embodiment of the disclosure.

FIG. 12 is an illustrative underside view of the apparatus shown in FIGS. 9-11 in accordance with one example embodiment of the disclosure.

FIG. 13 is an illustrative side view of the apparatus shown in FIGS. 9-12 in accordance with one example embodiment of the disclosure.

FIG. 14 is an illustrative perspective details view of the apparatus shown in FIG. 9-13 in accordance with one example embodiment of the disclosure.

This disclosure will now provide a more detailed and specific description that will refer to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

Certain relationships between features of the insert and bottle are described herein using the term “substantially” or “substantially equal.” As used herein, the terms “substantially” and “substantially equal” indicate that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variation that, using mathematical and industrial principles accepted in the art (e.g., rounding, measurement or other systematic errors, manufacturing tolerances, etc.), would not vary the least significant digit of the dimensions. As used herein, the term “substantially parallel” indicates that the parallel relationship is not a strict relationship and does not exclude functionally similar variations therefrom. As used herein, the term “substantially orthogonal” or “substantially perpendicular” indicates that the orthogonal relationship is not a strict relationship and does not exclude functionally similar variations therefrom.

This disclosure relates to, among other things, systems, methods, and apparatuses for an anti-colic airpath for a bottle. In embodiments, an apparatus includes an insert configured to be positioned between a nipple and an opening of a bottle when the nipple is mounted to the bottle. The insert is configured to facilitate airflow out of the bottle and through an interface between the nipple and the bottle when the nipple is dispensing fluid from within the bottle.

In embodiments, a system includes a nipple, an insert, and a bottle with an opening. The insert is positioned between the nipple and the opening of the bottle when the nipple is mounted to the bottle. The insert is configured to facilitate airflow out of the bottle and through an interface between the nipple and the bottle when the nipple is dispensing fluid from within the bottle.

In embodiments, a method includes providing an insert, and positioning the insert between a nipple and an opening of a bottle when the nipple is mounted to the bottle. The insert facilitates airflow out of the bottle and through an interface between the nipple and the bottle when the nipple is dispensing fluid from within the bottle.

Embodiments of the disclosure can provide a technical solution to the problem of venting air from a closed bottle when fluid is being dispensed from the bottle to an infant through a nipple. When the bottle is in use, air in the bottle is not passed though the fluid in the bottle and the air is permitted to be vented outside the bottle thereby reducing any vacuum build up. As a result, an infant drinking fluid from the bottle through the nipple should experience less colic or related symptoms.

In one example embodiment, a system and apparatus for an anti-colic airpath for a bottle can include an insert configured to be positioned between a nipple and an opening of a bottle, the insert facilitating airflow out of the bottle and between an interface between the nipple and the bottle when the nipple is mounted to the bottle and the nipple is dispensing fluid from within the bottle. For example, the insert may be included in the NUK® Smooth Flow™ Anti-Colic Bottle, available commercially from NUK® USA LLC, Atlanta, Ga., USA. In some embodiments, the insert can be used with certain nipples and related technologies, such as those described by European Patent Publication No. 3072097B1. In any instance, airflow through the insert can be directed to an interface between the nipple and the bottle, wherein capillary flow through the interface can permit air from within the bottle to be vented outside of the bottle. The insert can include or otherwise act as a valve to facilitate the air flow out of the bottle while the bottle is dispensing fluid from the nipple, and thereby reduce any vacuum build up within the bottle.

In one embodiment, the insert may include a lower ring configured to mount to an upper surface of the opening of the bottle, and may further include an upper ring mounted to the lower ring and configured to mount to the nipple. The insert may include a valve with an airflow path from an outer circumferential surface of the lower ring or the upper ring to an inner circumferential surface of the lower ring or the upper ring.

In one embodiment, the insert includes a valve having a substantially cylindrical shape and an airflow path that permits air flow along an interface between the nipple and the bottle to vent air from inside the bottle to outside of the bottle. By permitting air within the bottle to not mix with or otherwise pass through fluid in the bottle, the airflow through the insert and along the interface between the nipple and the bottle can ventilate air from within the bottle to outside of the bottle, and thereby reduce the colic effect or related symptoms in an infant.

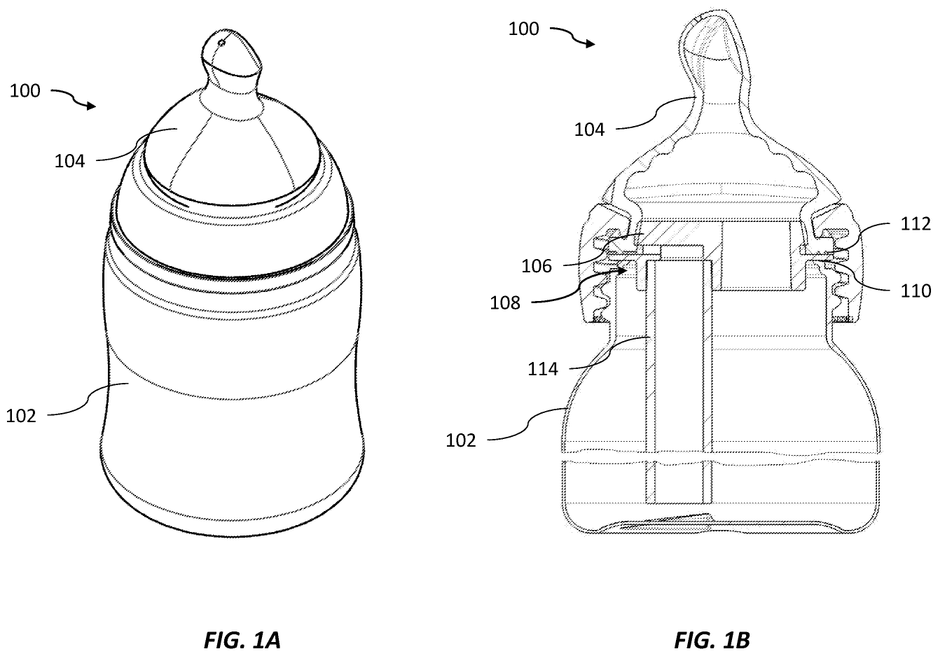

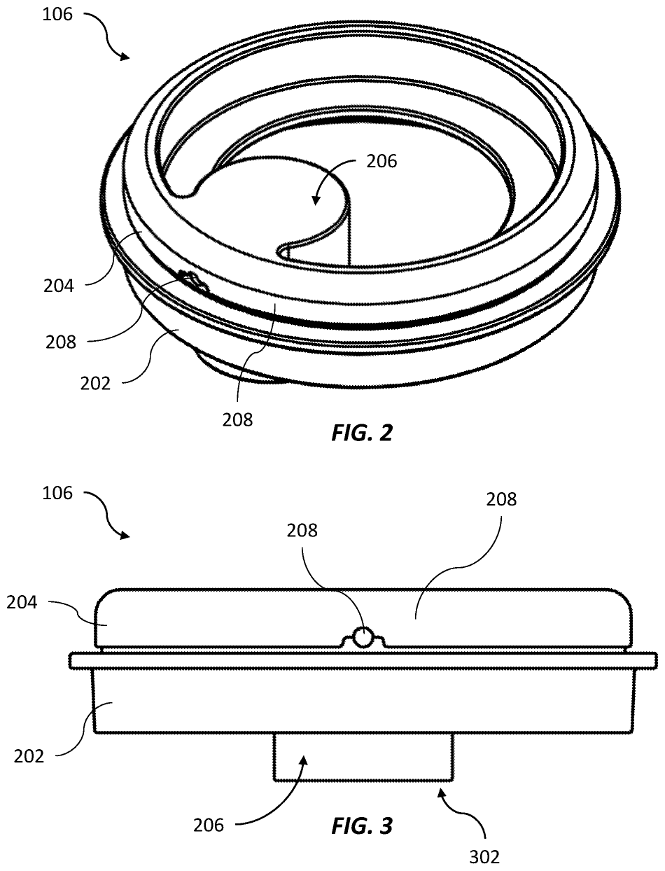

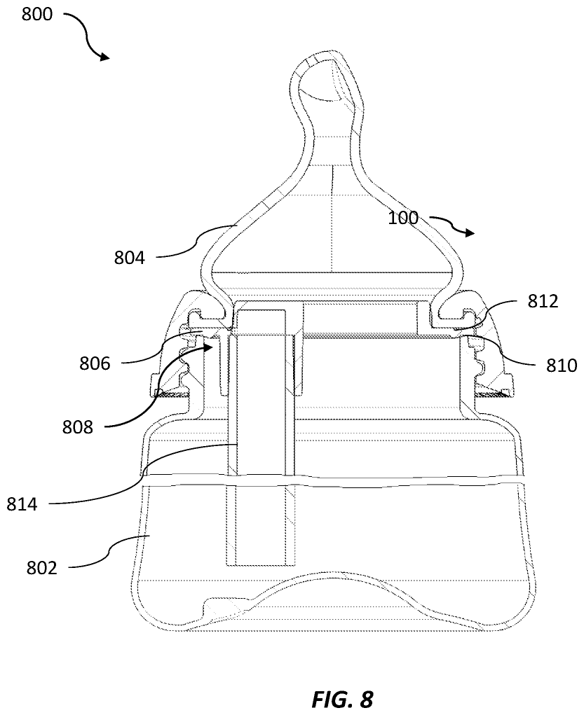

Turning to the figures, FIGS. 1A-1B depict an illustrative perspective view of a system 100 in accordance with one example embodiment of the disclosure. As shown in FIGS. 1A and 1B, the system 100 can include a bottle 102, nipple 104, and insert 106. In some embodiments, the insert 106, also called an anti-colic disk, is positioned between the nipple 104 and an opening 108 of the bottle 102 when the nipple 104 is mounted to the bottle 102. The nipple, in some instances, may include a threaded mounting ring to mount the nipple 104 to a correspondingly threaded opening of the bottle 102. In some embodiments, the insert 106 can contact an upper surface 110 of the opening 108 of the bottle 102 when the nipple 104 is mounted to the bottle 102. The insert 106 may contact the nipple 104 when the nipple 104 is mounted to the bottle 102. In some embodiments, the insert 106 can interact with one or more channels, such as capillaries 112, in the nipple 104 to facilitate airflow. In other embodiments, including those depicted in FIGS. 7 and 8, the insert 106 can include one or more channels or capillaries instead of, or in addition to, one or more channels, such as capillaries, in the nipple 104. As shown in FIG. 7, one or more channels or capillaries in the insert 106 can be positioned around an outer circumference of a later surface of the insert 106. In any instance, the insert 106 can facilitate airflow to permit air inside the bottle to be vented along an interface between the nipple 104 and the bottle 102 when the nipple 104 is mounted to the bottle 102, and when the bottle 102 is in use by dispensing fluid through the nipple 104. In some embodiments, the insert 106 can couple to a tube 114 for facilitating airflow to a particular location within the bottle 102.

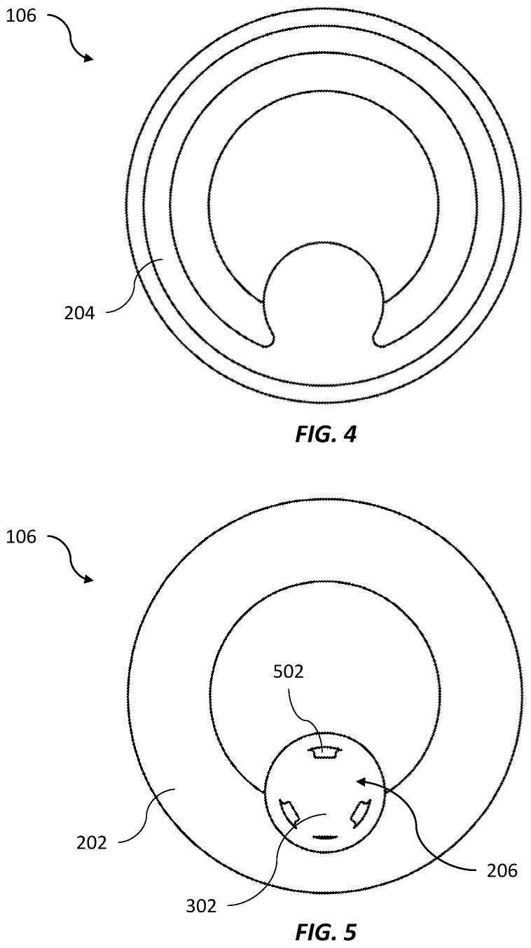

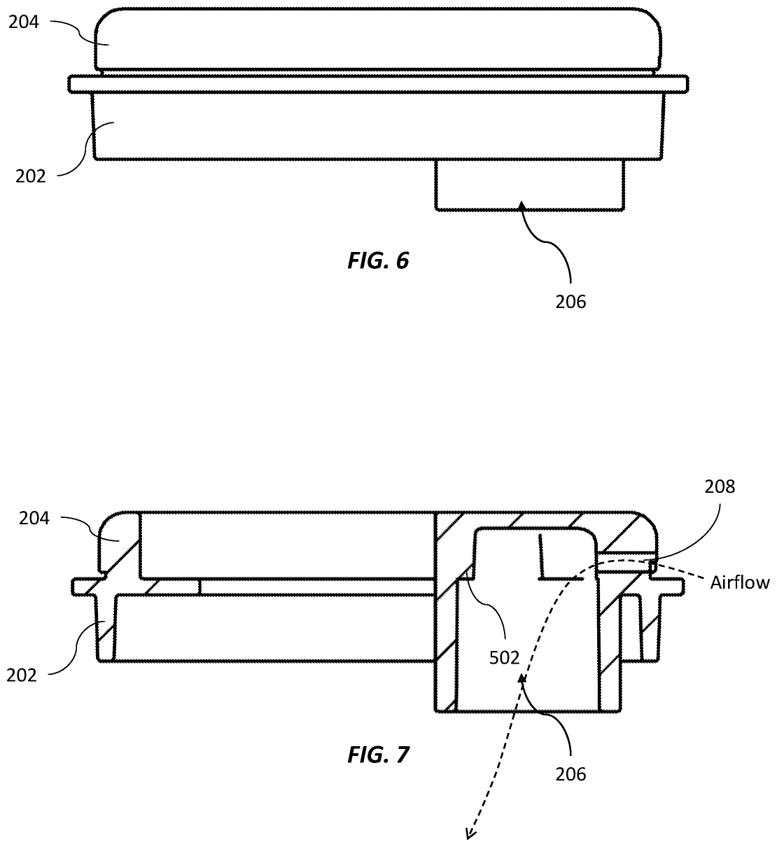

FIG. 2 depicts an illustrative perspective view of an insert 106 for an anti-colic airpath for a bottle in accordance with one example embodiment of the disclosure. In some embodiments, the insert 106 includes a lower ring 202 configured to mount to an upper surface of the opening 108 of the bottle 102. In some embodiments, the insert 106 includes an upper ring 204 mounted to the lower ring 202 and configured to mount to the nipple 104. In some embodiments, such as that shown in FIGS. 3-5, the insert 106 includes a valve 206 with an airflow path from an outer circumferential surface 208 of the upper ring 204 to an inner circumferential surface 302 of the upper ring 204. The airflow path may have one or more airflow inlets 208 on an outer circumferential surface of the upper ring 204. The airflow path may have one or more corresponding airflow outlets on the inner circumferential surface 302 of the upper ring 204. As shown in the sectional and cross-sectional views of the insert 106 in FIGS. 6 and 7, a circumferential channel or capillary can be positioned along the outer circumferential surface 208 at a lower portion of the upper ring 204 above the lower ring 202 of the insert 106. The circumferential channel or capillary can extend along some or all of the outer circumferential surface 208 of the insert 106. In some instances, the circumferential channel or capillary can be a series of channels or capillaries. In any instance, and as shown in these embodiments, a nipple 104 can be mounted to the insert 106, and air can flow along the circumferential channel or capillary towards the interface between the nipple 104 and the bottle 102. One skilled in the art will recognize other suitable configurations of channels or capillaries in the insert as well as airflow inlets and airflow outlets through the insert.

The valve 206 is depicted in FIG. 2 as extending vertically from an upper surface of the upper ring towards and slightly beyond the lower ring. The valve 206 is shown with an airflow path extending from an outer circumferential surface of the upper ring to an inner circumferential surface of the upper ring. In some instances, the valve may have an airflow path extending from an outer circumferential surface of the lower ring to an inner circumferential surface of the upper ring. One skilled in the art will recognize other suitable airflow paths through the insert and positioning of the valve to facilitate the airflow through the insert and out of the bottle.

As depicted in FIGS. 2-6, the valve 206 may have a substantially cylindrical shape and an airflow path that facilitates airflow towards an interface between the nipple and the bottle.

In one embodiment, an elongated tube 114 can be mounted from the valve 206 and extend downward towards a lower portion of the bottle 102. As shown in FIG. 5, one or more stops 502 can be positioned in the valve 206 to limit or restrict insertion of the tube 114 into the valve and to permit air to flow through the tube 114 and the air flow path through the insert 106. The tube 114 can be used to facilitate air flow from the lower portion of the bottle 102 through the tube 114 and towards the airflow path when the bottle 102 is turned upside down.

Turning now to FIG. 8, there is depicted an illustrative cross-sectional view of a system 800 in accordance with a second example embodiment of the disclosure. The system 800 can include a bottle 802, nipple 804, and insert 806. In some embodiments, the insert 806, also called an anti-colic disk, is positioned between the nipple 804 and an opening 808 of the bottle 802 when the nipple 804 is mounted to the bottle 802. The nipple, in some instances, may include a threaded mounting ring to mount the nipple 804 to a correspondingly threaded opening of the bottle 802. In some embodiments, the insert 806 can contact an upper surface 810 of the opening 808 of the bottle 802 when the nipple 804 is mounted to the bottle 802. The insert 806 may contact the nipple 804 when the nipple 804 is mounted to the bottle 802. In some embodiments, the insert can include one or more channels, such as capillaries 812, that facilitate airflow to permit air inside the bottle 802 to be vented along an interface between the nipple 804 and the bottle 802 when the nipple 804 is mounted to the bottle 802, and when the bottle 102 is in use by dispensing fluid through the nipple 804. In some embodiments, insert 806 couples to a tube 814 for facilitating airflow to a particular location within the bottle 802.

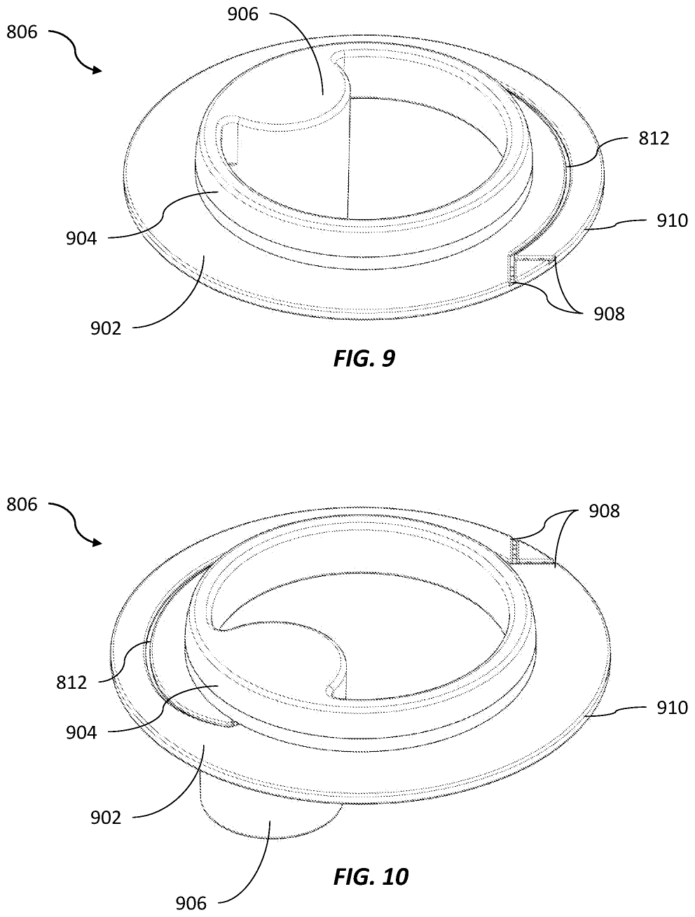

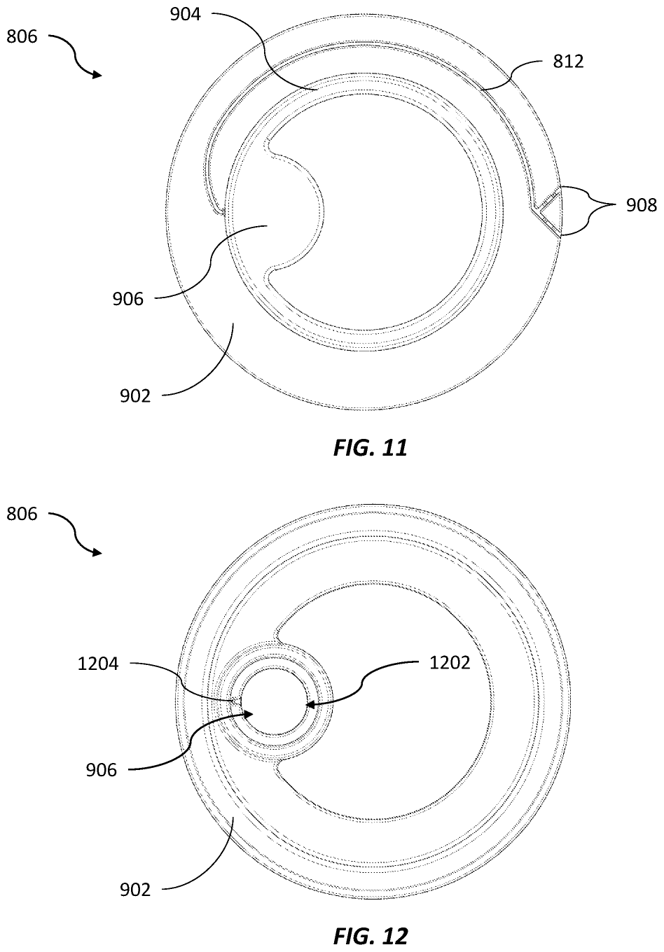

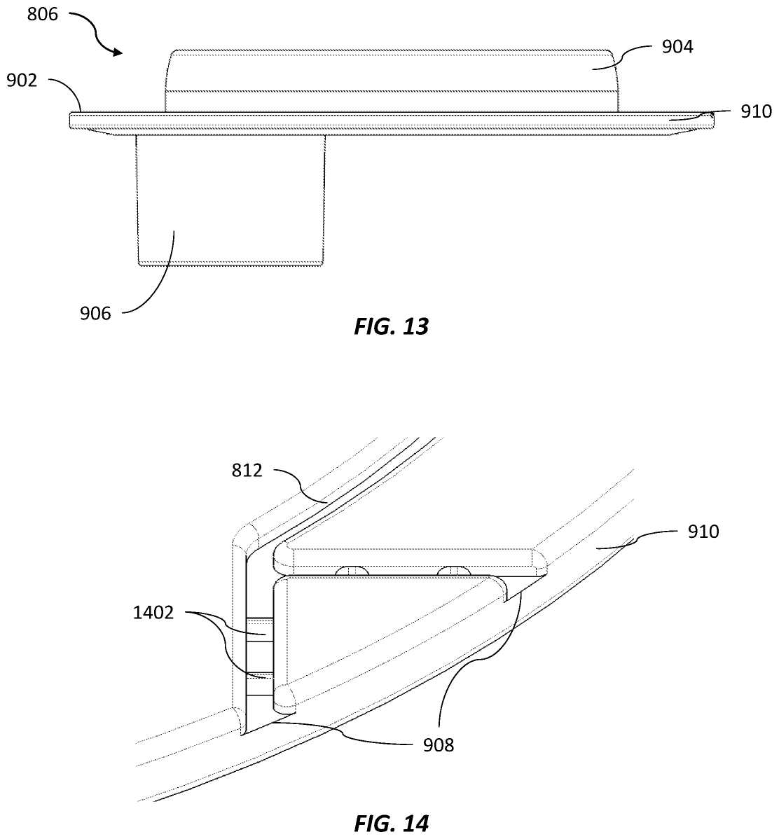

FIG. 9 depicts an illustrative perspective view of an insert 806 for an anti-colic airpath for a bottle in accordance with one example embodiment of the disclosure. In some embodiments, the insert 806 includes a disc 902 configured to mount to an upper surface of the opening 808 of the bottle 802. In some embodiments, the insert 806 includes an upper ring 904 mounted to the disc 902 and configured to mount to the nipple 804. In some embodiments, such as that shown in FIGS. 9-13, the insert 806 includes a valve 906 with an airflow path through capillary 812 on disc 902 to an inner circumferential surface 1202 of the insert 806. The airflow path may have one or more airflow inlets 908 on an outer circumferential surface 910 of the disc 902. The airflow path may have one or more corresponding airflow outlets 1204 on the inner circumferential surface 1202 of the insert 806. One skilled in the art will recognize other suitable configurations of airflow inlets and airflow outlets for the insert.

As depicted in FIG. 14, capillary 812 on disc 902 may have one or more barriers 1402 configured to prevent leakage of fluid from inside bottle 802.

Though the disclosed examples include particular arrangements of a number of parts, components, features, and aspects, the disclosure is not limited to only those examples or arrangements shown. Any one or more of the parts, components, features, and aspects of the disclosure can be employed alone or in other arrangements of any two or more of the same.

Although certain product features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, apparatuses, devices, and techniques, individually and in combination. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. An apparatus comprising:
an insert configured to be positioned between a nipple and an opening of a bottle when the nipple is mounted to the bottle,
wherein the insert is configured to facilitate airflow out of the bottle and through an interface between the nipple and the bottle when the nipple is dispensing fluid from within the bottle.

2. The apparatus of claim 1, wherein the insert comprises:
a lower ring configured to mount to an upper surface of the opening of the bottle;
an upper ring mounted to the lower ring and configured to mount to the nipple; and
a valve with an airflow path from an outer circumferential surface of the lower ring or the upper ring to an inner circumferential surface of the lower ring or the upper ring.

3. The apparatus of claim 2, wherein the valve is configured to receive a tube that extends towards a lower portion of the bottle.

4. The apparatus of claim 1, wherein the insert comprises an upper ring, a lower ring or a disc, and a valve with an airflow path having one or more airflow inlets on an outer circumferential surface of the lower ring, the disc, or the upper ring.

5. The apparatus of claim 1, wherein the insert comprises:
an upper ring configured to mount to the nipple;
a disc mounted to the upper ring having a surface for engaging with the opening of the bottle; and
a valve with an airflow path from an outer circumferential surface of the disc to an inner circumferential surface of the insert.

6. The apparatus of claim 1, wherein the insert comprises a valve having a substantially cylindrical shape and an airflow path that is adjacent to an interface between the nipple and the bottle.

7. A system comprising:
a nipple;
an insert;
a bottle with an opening,
wherein the insert is positioned between the nipple and the opening of the bottle when the nipple is mounted to the bottle,
wherein the insert is configured to facilitate airflow out of the bottle and through an interface between the nipple and the bottle when the nipple is dispensing fluid from within the bottle.

8. The system of claim 7, wherein the insert comprises:
a lower ring contacting an upper surface of the opening of the bottle when the nipple is mounted to the bottle;
an upper ring mounted to the lower ring and contacting the nipple when the nipple is mounted to the bottle; and
a valve with an airflow path from an outer circumferential surface of the lower ring or the upper ring to an inner circumferential surface of the lower ring or the upper ring.

9. The system of claim 8, wherein the valve is configured to receive a tube that extends towards a lower portion of the bottle.

10. The system of claim 7, wherein the insert comprises an upper ring, a lower ring or a disc, and a valve with an airflow path having one or more airflow inlets on an outer circumferential surface of the lower ring, the disc, or the upper ring.

11. The system of claim 7, wherein the insert comprises an upper ring, a disc, and a valve with an airflow path from an outer circumferential surface of the disc to an inner circumferential surface of the insert.

12. The system of claim 7, wherein the insert comprises a valve having a substantially cylindrical shape and an airflow path that is adjacent to an interface between the nipple and the bottle.

13. A system comprising:
a nipple;
a bottle with an opening; and
the apparatus of claim 1, wherein the insert includes:
a lower ring contacting an upper surface of the opening of the bottle when the nipple is mounted to the bottle,
an upper ring mounted to the lower ring and contacting the nipple when the nipple is mounted to the bottle, and
a valve with an airflow path from an outer circumferential surface of the lower ring or the upper ring to an inner circumferential surface of the lower ring or the upper ring,
wherein the airflow path is configured to facilitate airflow out of the bottle via an interface between the nipple and the bottle when the nipple is dispensing fluid from within the bottle.

14. A method comprising:
providing an insert; and
positioning the insert between a nipple and an opening of a bottle when the nipple is mounted to the bottle,
wherein the insert facilitates airflow out of the bottle and through an interface between the nipple and the bottle when the nipple is dispensing fluid from within the bottle.

15. The method of claim 14, wherein positioning the insert between the nipple and the opening of the bottle comprises mounting a lower ring of the insert into the opening of the bottle and mounting an upper ring of the insert into the nipple.

16. The method of claim 14, wherein the insert comprises an upper ring, lower ring, and a valve with an airflow path from an outer circumferential surface of the lower ring or the upper ring to an inner circumferential surface of the lower ring or the upper ring.

17. The method of claim 14, wherein the insert comprises an upper ring, a lower ring, and a valve with an airflow path having one or more airflow inlets on an outer circumferential surface of the lower ring or the upper ring.

18. The method of claim 14, wherein the insert comprises an upper ring, a lower ring, and a valve with an airflow path having one or more airflow outlets on an inner circumferential surface of the lower ring or the upper ring.

19. The method of claim 14, wherein the insert comprises a valve having a substantially cylindrical shape and an airflow path that is adjacent to an interface between the nipple and the bottle.

20. The method of claim 14, wherein the insert comprises a valve configured to receive a tube extending from the valve to a lower portion of the bottle.
